(19) United States
(12) Patent Application Publication
(10) Pub. No.: US 2026/0001166 A1
(43) Pub. Date: Jan. 1, 2026

(54) METHOD, SYSTEM AND APPARATUS FOR PROCESSING SYSTEM COMPONENT SURFACE MODIFICATION

(71) Applicant: ASM IP Holding B.V., Almere (NL)

(72) Inventors: David Groechel, Scottsdale, AZ (US); Christopher Falcone, Chandler, AZ (US); Osama Khalil, Phoenix, AZ (US); Ryan Peters, Mesa, AZ (US); Jeffrey Hintz, Phoenix, AZ (US)

(21) Appl. No.: 19/247,431

(22) Filed: Jun. 24, 2025

Related U.S. Application Data
(60) Provisional application No. 63/664,641, filed on Jun. 26, 2024.

(51) Int. Cl. B23K 26/34

(52) U.S. Cl. CPC B23K 26/34

(57) ABSTRACT

In an aspect, disclosed herein are a methods, systems and apparatus for modifying a component surface comprising, contacting the surface, with an laser beam, the surface comprising a semiconductor tool manufacturing component; modifying the surface responsive to the contacting, wherein the modifying the surface comprises forming, by micro-machining, etching, ablating, ionizing, anodizing, oxidizing, texturing, or roughening, or a combination thereof, a functional feature in the surface.

### CROSS-REFERENCE TO RELATED APPLICATIONS

This application claims priority to U.S. Provisional Patent Application Ser. No. 63/664,641 filed Jun. 26, 2024 titled METHOD, SYSTEM AND APPARATUS FOR PROCESSING SYSTEM COMPONENT SURFACE MODIFICATION, the disclosure of which is hereby incorporated by reference in its entirety.

### FIELD OF INVENTION

The present disclosure generally relates to fabrication of semiconductor manufacturing tool components. More specifically, it relates to methods, systems and apparatus suitable for laser surface modification of component parts to influence surface characteristics and tribological properties.

### BACKGROUND OF THE DISCLOSURE

As integrated circuit devices shrink, process and contamination control are becoming increasingly critical and challenging.

For many semiconductor fabrication processes, a semiconductor substrate (for example, a “wafer”) may be heated within a reaction chamber. In some instances, the substrate is seated on a heated susceptor. Films comprising various materials may be deposited on the substrate by a variety of methods including atomic layer deposition (ALD) and chemical vapor deposition (CVD).

During the use of the reaction chamber, emissivity may change on chamber component surfaces as process films are deposited thereon, which occurs as the process film is likewise being deposited on the substrate. This change in emissivity may impact the time required to reach a stable process (burn-in time) in which the film deposition on the substrate is consistent. In addition to unusable wafers which may be processed during burn-in time, production time may also be lost.

Coatings or surface treatments may be applied to reaction chamber components, such as a showerhead, for protection and/or desired emissivity. Grit blasting, a common surface treatment, propels abrasive materials against component surfaces to remove contaminants and roughened or texture the surface to improve adhesion and achieve a desired emissivity. However, this method can leave trace metals on parts, introducing contamination and defects. Further, blasting media (e.g., aluminum oxide) can become lodged within features on the treated surface introducing additional contaminants and interfering with subsequent processes. The destructive nature of grit blasting can also damage delicate components, generate dust, and may require specialized cleaning and filtration systems.

Other sources of particle contamination may come from deposition on component parts within the chamber such as showerheads, liners, shields, and/or heaters. During the manufacturing process, materials often condense from the gas phase onto the internal surfaces of the chamber and surfaces of chamber components. This condensed matter forms solid masses prone to detaching or flaking off from the surfaces during or in between process cycles. This detachment can be caused by various factors such as vibration, gas flow, or thermal cycling. Poor adhesion of the film over time may cause the film material to crack or separate from the chamber wall or other components, which may lead to an increase in the number of undesired particles within the reaction chamber. Once detached, these particles become airborne within the chamber. They can then impinge upon and settle on the substrate leading to device failures and reduced manufacturing yields.

While conventional surface treatments have worked for their intended purposes, there is a desire for alternative surface modification methods that improve process control and reduce contamination risks.

### SUMMARY OF THE DISCLOSURE

This summary is provided to introduce a selection of concepts in a simplified form. These concepts are described in further detail in the detailed description of examples of the disclosure below. This summary is not intended to identify key features or essential features of the claimed subject matter, nor is it intended to be used to limit the scope of the claimed subject matter.

In an aspect, disclosed herein are a methods, systems and apparatus for modifying a component surface comprising, contacting the surface, with a laser beam, the surface comprising a semiconductor tool manufacturing component; modifying the surface responsive to the contacting, wherein the modifying the surface comprises forming, by micro-machining, etching, ablating, ionizing, anodizing, oxidizing, texturing, or roughening, or a combination thereof, a functional feature in the surface.

In some examples, the semiconductor tool manufacturing component is a reaction chamber assembly component.

In some examples, the functional feature is selected based on a process to be performed within the reaction chamber.

In some examples, the method further comprises exposing the surface to an ambient surface treatment before, during or after, the contacting.

In some examples, the ambient surface treatment comprises oxygen (O₂), ozone (O₃), nitrogen (N₂), ammonia (NH₃), carbon dioxide (CO₂), carbon monoxide (CO), or hydrogen (H₂), or a combination thereof.

In some examples, the modifying the surface comprises forming a functional feature comprising a pattern, roughening the surface, altering a roughness of the surface, texturing the surface, altering a texture of the surface, altering an emissivity of the surface, or changing a surface energy of the surface, or a combination thereof.

In some examples, the functional feature is between about 0.01 mm² and about 1 mm² and comprises an aspect ratio of up to 10:1 in the surface.

In some examples, the surface comprises at least one of: metal, plastic, polymer, stainless steel, stainless steel alloy, aluminum, aluminum alloy, titanium, titanium alloy, quartz, nickel or ceramic.

In some examples, the functional feature is characterized by an emissivity of greater than about 0.7.

In some examples, the functional feature is characterized by a roughness of greater than Ra of between about 0.5 μm and about 20 μm.

In some examples, the functional feature is characterized by a roughness of less than about 7 μm.

In some examples, the functional feature is characterized by a wettability wherein the contact angle greater than about 90°.

In some examples, the functional feature is characterized by a hydrophobicity wherein the contact angle is greater than about 90°.

In some examples, the functional feature is characterized by a hydrophilicity of wherein the contact angle less than about 90°.

In some examples, the laser beam is a nanosecond laser, a picosecond laser or a femtosecond laser.

In some examples, the laser beam has a pulse duration that is between about 2 nanoseconds and about 500 nanoseconds.

In some examples, the laser beam may have a pulse duration that is between about 0.2 picoseconds and about 1 picosecond.

In some examples, the laser beam may have a pulse duration that is between about 150 femtoseconds and about 1000 femtoseconds.

In some examples, the laser beam may have a frequency that is between about 1 kHz and about 10000 kHz.

In some examples, the laser beam may have a frequency that is between about 50 kHz and about 5500 kHz.

In some examples, the laser beam may have a scan speed that is between about 10 mm/s and about 5000 mm/s.

In some examples the method may further comprise comprising adjusting a frequency of the laser beam, a scan speed of the laser beam, or a combination thereof to avoid pulse overlap.

In some examples, the laser beam may have a wavelength that is 532 nm, 515 nm, or 1064 nm.

For purposes of summarizing the invention and the advantages achieved over the prior art, certain objects and advantages of the invention have been described herein above. Of course, it is to be understood that not necessarily all such objects or advantages may be achieved in accordance with any particular example of the invention. Thus, for example, those skilled in the art will recognize that the invention may be embodied or carried out in a manner that achieves or optimizes one advantage or group of advantages as taught or suggested herein without necessarily achieving other objects or advantages as may be taught or suggested herein.

All of these examples are intended to be within the scope of the invention herein disclosed. These and other examples will become readily apparent to those skilled in the art from the following detailed description of certain examples having reference to the attached figures, the invention not being limited to any particular example(s) disclosed.

### BRIEF DESCRIPTION OF THE DRAWING FIGURES

While the specification concludes with claims particularly pointing out and distinctly claiming what are regarded as examples of the invention, the advantages of examples of the disclosure may be more readily ascertained from the description of certain examples of the examples of the disclosure when read in conjunction with the accompanying drawings, in which:

FIG. 1 illustrates a schematic diagram of an example optical beam contacting a workpiece, in accordance with examples of the present technology.

FIG. 2A is a schematic illustrating an example of semiconductor manufacturing system 200 in accordance with examples of the present technology.

FIG. 2B is a schematic illustrating an example of a reaction chamber assembly in accordance with examples of the present technology.

FIG. 3 is a schematic diagram illustrating examples of components a workpiece 102 may comprise, in accordance with examples of the present technology.

FIG. 4 illustrates an array of examples of functional features 116 that may be formed on workpiece 102, in accordance with examples of the present technology.

FIG. 5 is a schematic diagram illustrating an example of a laser processing system 500, in accordance with examples of the present technology.

FIG. 6 is a schematic diagram illustrating an example of a laser processing system 600, in accordance with examples of the present technology.

FIG. 7 is a flow chart illustrating an example method for modifying a component surface according to aspects of the disclosed technology.

It will be appreciated that elements in the figures are illustrated for simplicity and clarity and have not necessarily been drawn to scale. For example, the dimensions of some of the elements in the figures may be exaggerated relative to other elements to help improve understanding of illustrated embodiments of the present disclosure.

### DETAILED DESCRIPTION

The detailed description of various examples herein makes reference to the accompanying drawings, which show the exemplary examples by way of illustration. While these exemplary examples are described in sufficient detail to enable those skilled in the art to practice the disclosure, it should be understood that other examples may be realized and that logical, chemical, and/or mechanical changes may be made without departing from the spirit and scope of the disclosure. Thus, the detailed description herein is presented for purposes of illustration only and not of limitation. For example, the steps recited in any of the method or process descriptions can be executed in any combination and/or order and are not limited to the combination and/or order presented. Further, one or more steps from one of the disclosed methods or processes can be combined with one or more steps from another of the disclosed methods or processes in any suitable combination and/or order. Moreover, any of the functions or steps can be outsourced to or performed by one or more third parties. Furthermore, any reference to singular includes plural examples, and any reference to more than one component can include a singular example.

Although certain examples are disclosed below, it will be understood by those in the art that the disclosure extends beyond the specifically disclosed examples and/or uses of the disclosure and obvious modifications and equivalents thereof. Thus, it is intended that the scope of the disclosure should not be limited by the particular examples described herein.

The illustrations presented herein are not meant to be actual views of any particular material, apparatus, structure, or device, but are merely representations that are used to describe examples of the disclosure.

As used herein, the term “substrate” can refer to any underlying material or materials that may be used, or upon which, a device, a circuit, or a film/layer may be formed. A substrate can include a bulk material, such as silicon (e.g., single-crystal silicon), other Group IV materials, such as germanium, or other semiconductor materials, such as Group II-VI or Group III-V semiconductor materials, and can include one or more layers overlying or underlying the bulk material. Further, the substrate can include various features, such as recesses, protrusions, and the like formed within or on at least a portion of a layer of the substrate. By way of examples, a substrate can include bulk semiconductor material and an insulating or dielectric material layer overlying at least a portion of the bulk semiconductor material.

As used herein, the term “atomic layer deposition” (ALD) can refer to a vapor deposition process in which deposition cycles, preferably a plurality of consecutive deposition cycles, are conducted in a process chamber. Typically, during each cycle the precursor is chemisorbed to a deposition surface (e.g., a substrate surface or a previously deposited underlying surface such as material from a previous ALD cycle), forming a monolayer or sub-monolayer that does not readily react with additional precursor (i.e., a self-limiting reaction). Thereafter, if necessary, a reactant (e.g., another precursor or reaction gas) can subsequently be introduced into the process chamber for use in converting the chemisorbed precursor to the desired material on the deposition surface. Typically, this reactant is capable of further reaction with the precursor. Further, purging steps can also be utilized during each cycle to remove excess precursor from the process chamber and/or remove excess reactant and/or reaction byproducts from the process chamber after conversion of the chemisorbed precursor. Further, the term “atomic layer deposition,” as used herein, is also meant to include processes designated by related terms such as, “chemical vapor atomic layer deposition”, “atomic layer epitaxy” (ALE), molecular beam epitaxy (MBE), gas source MBE, or organometallic MBE, and chemical beam epitaxy when performed with alternating pulses of precursor composition(s), reactive gas, and purge (e.g., inert carrier) gas.

As used herein, the term “chemical vapor deposition” (CVD) can refer to any process wherein a substrate is exposed to one or more volatile precursors, which react and/or decompose on a substrate surface to produce a desired deposition.

As used herein, the term “cyclic deposition” may refer to the sequential introduction of one or more precursors and/or reactants into a reaction chamber to deposit a film over a substrate and includes deposition techniques such as atomic layer deposition and cyclic chemical vapor deposition.

As used herein, the terms “layer,” “film,” and/or “thin film” can refer to any continuous or non-continuous structures and material deposited by the methods disclosed herein. For example, “layer,” “film,” and/or “thin film” could include 2D materials, nanorods, nanotubes, or nanoparticles or even partial or full molecular layers or partial or full atomic layers or clusters of atoms and/or molecules. “Layer,” “film,” and/or “thin film” can comprise material or a layer with pinholes, but still be at least partially continuous.

A number of example materials are given throughout the examples of the current disclosure, it should be noted that the chemical formulas given for the example materials should not be construed as limiting and that the non-limiting example materials given should not be limited by a given example stoichiometry.

Further, in this disclosure, any two numbers of a variable can constitute a workable range of the variable, and any ranges indicated can include or exclude the endpoints. Additionally, any values of variables indicated (regardless of whether they are indicated with “about” or not) can refer to precise values or approximate values and include equivalents, and can refer to average, median, representative, majority, or the like. Further, in this disclosure, the terms “including,” “constituted by” and “having” can refer independently to “typically or broadly comprising,” “comprising,” “consisting essentially of,” or “consisting of” in some examples. In this disclosure, any defined meanings do not necessarily exclude ordinary and customary meanings in some examples.

As noted above, conventional surface treatment using grit blasting has several drawbacks, including contamination due to trapped blast media, trace metals and difficulty controlling the process. Disclosed herein are methods, systems and apparatus for modifying a surface of a semiconductor manufacturing tool component to form a functional feature thereon using a nanosecond, picosecond or femtosecond pulsed laser.

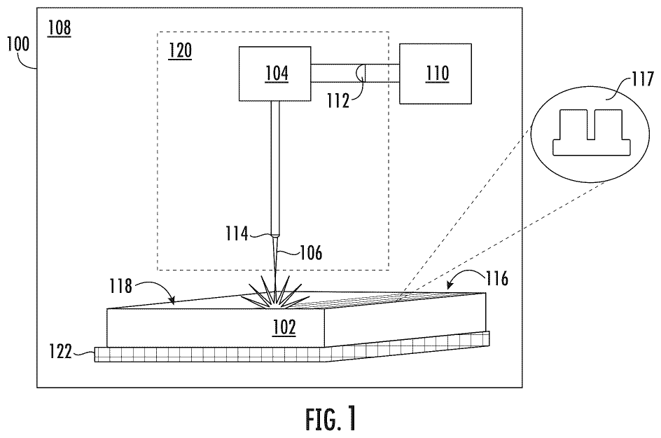

FIG. 1 is a schematic diagram illustrating an example of a laser processing system 100, in accordance with examples of the present technology. Laser processing system 100 may be configured to contact a surface 118 of workpiece 102 with a pulsed optical beam 106 to modify surface 118. In various example, workpiece 102 may comprise (or consist of or consist essentially of) a variety of materials, including, but not limited to, metal, plastic, polymer (e.g., high density polyethylene and/or polyether ether ketone), stainless steel and alloys thereof, aluminum and alloys thereof, titanium and alloys thereof, quartz, nickel and/or ceramic.

In an example, pulsed laser 106 can be used to texturize, pattern, microstructure, roughen, smooth and/or otherwise modify surface 118 to tune surface characteristics to improve and/or stabilize various semiconductor manufacturing processes.

In an example, laser processing system 100 may comprise a pulsed optical beam source 110 configured to generate a pulse optical beam 106. In an example, pulsed optical beam source 110 may couple optical beam 106 into an optical assembly 120 comprising various optical components. Such optical components may include but are not limited to a beam expander 112 and/or optical lens 114 to shape and focus optical beam 106 onto workpiece 102. Additionally or alternatively, beam expander 112 and/or optical lens 114 may be configured to perform optical beam manipulation to direct the optical beam 106 to workpiece 102 such as expanding, focusing, diffusing and/or polarizing optical beam 106. In an example, optical assembly 120 may include a scanner 104 to control the position, direction and speed of optical beam 106 to move the optical beam 106 over surface 118. Scanner 104 may comprise a galvanometer scanner, a polygon scanner, or a rotating mirror scanner, or the like or a combination thereof. In an example, optical assembly 120 may include a stage 122 to support workpiece 102. Stage 122 may be adjustable in the x, y and z-direction.

In an example, one or more controller 108 components may be in communication with one or more components of laser processing system 100 to control various operations of laser processing system 100. Controller 108 may be programmed to cause optical beam 106 to modify a surface 118 to form or cause to be formed a functional feature 116 in surface 118. For example, a controller 108 may be configured to control one or more optical components of optical assembly 120, such as but not limited to, beam expander 112 and/or scanner 104 to control various parameters, including one or more of but not limited to, beam diameter, beam shape, focal point, position, direction and scan speed. Controller 108 may additionally or alternatively control pulsed optical beam source 110, to regulate optical beam 106 parameters and/or characteristics comprising at least one of but not limited to: pulse width, frequency, fluence, power level, or the like or a combination thereof. In an example, controller 108 may additionally or alternatively control stage 122 to move workpiece 102 in the x, y, and z directions. This allows for precise positioning of the workpiece 102 relative to the optical beam 106.

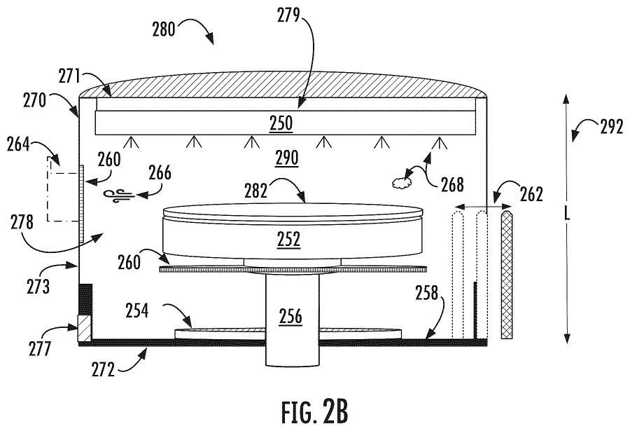

In an example, workpiece 102 may comprise a reaction chamber component (see FIG. 3). Functional feature 116 may impart selected surface properties to such a component to improve semiconductor manufacturing processes by improving and/or stabilizing interactions between reaction chamber components and process chemistries. Functional feature 116 may comprise selected and/or modified surface characteristics including but not limited to hydrophilicity, hydrophobicity, wettability, anisotropic wettability, emissivity, friction, surface energy, crystalline structure and/or oxidation, or the like or combinations thereof. Functional feature 116 may have one or more two- or three-dimensional features 117 dimensioned in a range of between about 0.01 mm² and about 1 mm². Feature(s) 117 may comprise an aspect ratio in the surface of up to about 10:1, or up to about 8:1, or up to about 6:1, or up to about 4:1, or up to about 2:1, or up to about 1:1.

In an example, process chemistries may comprise but are not limited to, precursors, reaction species, carrier/purge gases, by-products, and/or contaminants. For example, a functional feature 116 may change the wettability of a reaction chamber component to improve adhesion of deposited film and reduce delamination. In some examples, functional feature 116 may comprise more surface area and create micro-crevices that can enhance adhesion of condensed materials that form during the manufacturing process. The condensed materials adhere more strongly to the textured surfaces compared to smooth surfaces. By improving the adhesion of the condensed materials, the likelihood of these materials flaking off or detaching from the component surfaces is reduced. This is because the increased surface area and micro-crevices provide more points of contact and thus stronger adhesion. With fewer particles detaching from the component surfaces, there are fewer airborne particles that can settle on the wafer substrate. This results in less contamination of the wafer, leading to fewer defects and higher manufacturing yields. Texturing the component surfaces allows for better control over the deposition of materials during the manufacturing process. It can help ensure that the deposition is uniform and consistent improving quality and performance of the semiconductor devices.

In another example, functional feature 116 may impart selected surface properties to a reaction chamber component to improve semiconductor manufacturing processes by improving and/or stabilizing interactions between reaction chamber components and process conditions. Process conditions may comprise but are not limited to, heat, radiation and/or pressure. For example, functional feature 116 may change the emissivity of a reaction chamber component to improve process stability without requiring long burn-in times by pre-seasoning the component.

A relationship between surface characteristics and processing chemical material properties may be calculated to select one or more functional features 116 to be arranged on surface 118. Dimensions, microstructure(s), texture(s), pattern(s), roughness, or the like, or combinations thereof may be correlated to a desired behavior or interaction of processing chemicals with surface 118. For example, it may be desirable to improve adhesion on a particular surface therefore a desirable functional feature 116 may be a wettable microstructure to improve condensation and/or adhesion of processing chemicals to the surface. Additionally, surface stress of a deposited material impacts adhesion and may be modified by functional feature 116 dimensions, such as, a texture, microstructure and/or pattern's depth and width. By adjusting material surface stress adhesion may be further improved, potentially mitigating delamination issues. Additionally, the speed of the laser scan and the line spacing are adjustable parameters that influence the surface stress and adhesion quality.

In an example, optical beam 106 parameters, including but not limited to, power, frequency, pulse length, fluence and overlap of laser spots, can be controlled to achieve the desired functional feature 116. In an example, adjusting a frequency or a scan speed or a combination thereof can avoid or reduce pulse overlap which can damage surface 118. In various examples, optical beam 106 may comprise different beam shapes, such as a top hat, donut, or Gaussian. Beam shapes may be selected depending upon the surface modification requirements. Use of specific beam shapes such as a top hat may create more uniform functional features 116 and/or reduce the frequency of laser application needed to achieve the desired surface texture.

In an example, pulsed laser source 110 may be a nanosecond pulsed laser source, a picosecond pulsed laser source or a femtosecond laser source, or a combination thereof.

Nanosecond, picosecond, and femtosecond pulsed lasers are differentiated by their pulse durations. Nanosecond lasers have an optical beam pulse duration on the order of about 10\hat{ }-9 seconds, picosecond lasers have a pulse duration of about 10\hat{ }-12 seconds and femtosecond lasers have a pulse duration of 10\hat{ }-15 seconds.

In an example, pulsed laser 106 may remove material from surface 118 in a non-contact process by contacting workpiece 102 with a high power-density beam, which is converted into heat. This heat can melt or volatilize the material, leading to material removal. The extent and quality of the material removal is determined by laser parameters such as pulse duration, specific laser energy, laser power, fluence, repetition rate, beam size, beam quality or Beam Parameter Product (BPP), divergence and workpiece 102 temperature. The region of a material that has had its properties altered due to the heat generated by contact with pulsed optical beam 106 is referred to as Heat Affected Zone (HAZ). In the case of pulsed lasers, the heat accumulation effect becomes a considerable issue. This is because with increasing average laser power and repetition rates, more heat is accumulated, which can affect the processing quality. The HAZ can significantly impact the quality and properties of the machined material.

The precision of pulsed lasers is proportional to their pulse duration. The shorter the pulse the less heat impact to the material receiving the pulse energy. Use of ultra-short, pulsed lasers (e.g., femtosecond pulsed lasers) removes materials by ionization in a Coulomb explosion where the intense electric field from the laser causes a molecule or crystal lattice to disintegrate due to the repulsion between positively charged atoms. This process starts when lasers excite the valence electrons, removing them and leaving behind charged ions. This weakens chemical bonds allowing the repulsion to split the solid apart, creating a plasma.

Femtosecond lasers, while high-precision are costly. However, they offer a non-thermal process that avoids damaging the material being treated, which enables, among other things, precision micromachining of very fine surface features, textures, roughness, patterns, or the like, or combinations thereof. The choice of laser for surface modification depends on the specific requirements such as the material to be processed, the desired surface characteristics, and the acceptable level of thermal impact.

In an example, laser source 110 may comprise a nanosecond laser source. In such an exemplary embodiment, optical beam 106 may have a pulse duration of between about 2 nanoseconds and about 500 nanoseconds, a frequency of between about 1 kHz and about 10000 kHz. Scanner 104 may have a scan speed of between about 10 mm/s and about 5000 mm/s. Laser beam, for example an optical laser beam, may have a wavelength of that is about 532 nm, about 515 nm, or about 1064 nm.

In an example, laser source 110 may comprise a picosecond laser source. In such an exemplary embodiment, laser beam 106 may have a pulse duration that is between about 0.2 picoseconds about 1 picoseconds a frequency that is between about 1 kHz and about 10000 kHz. Scanner 104 may have a scan speed that is between about 10 mm/s and about 5000 mm/s. Laser beam may have a wavelength of about 532 nm, about 515 nm, or about 1064 nm.

In another example, laser source 110 may comprise a femtosecond laser source. In such an exemplary embodiment, optical beam 106 may have a pulse duration of about 150-1000 femtoseconds, a frequency of about 1-10000 kHz or about 50-5500 kHz. Scanner 104 may have a scan speed of about 10-5000 mm/s. Optical beam may have a wavelength of about 532 nm, 515 nm, or 1064 nm.

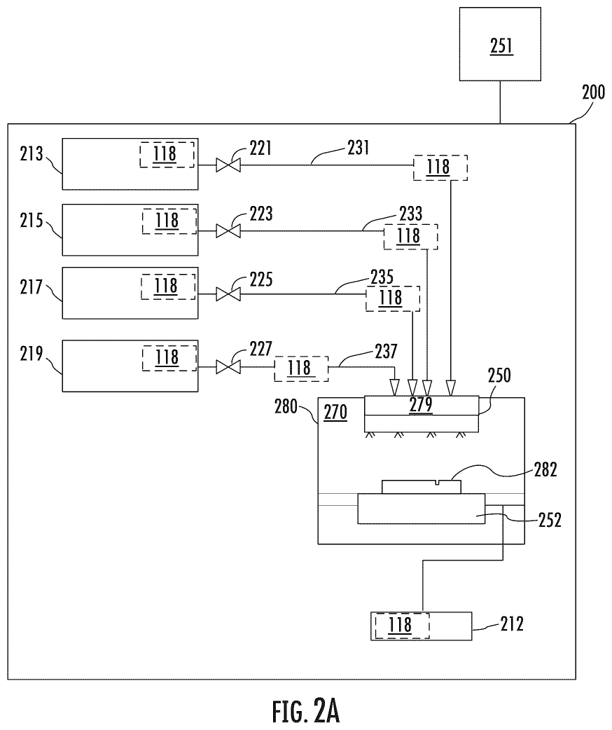

Turning now to FIG. 2A, a semiconductor manufacturing system 200, for processing a substrate 282, is illustrated. System 200 includes a reaction chamber assembly 280 including reaction chamber 270, a susceptor 252, a gas distribution system 250 (also referred to herein as a “showerhead”), and a vacuum source 212. System 200 further includes a first reactant gas source 213, optionally a second reactant gas source 215, an inert gas source 219, one or more gas lines 231-237 and respective flow controllers 221-227. System 200 may include one or more controllers 251 configured to control gas flow (e.g., by monitoring flow rates and controlling valves, motors, heaters, cooling devices and/or vacuum source 212 to execute various semiconductor manufacturing processes. System 200 may also include a gas manifold block 279. Reaction chamber 270 may be used to deposit material onto and/or etch material from a surface of a substrate 282. Reaction chamber 270 may be a standalone reactor or part of a cluster tool. Further, reaction chamber 270 may be dedicated to deposition, etch, clean, or treatment processes as described herein, or reaction chamber 270 may be used for multiple processes—e.g., for any combination of deposition, etch, clean, and treatment processes.

In an example, system 200 may comprise a surface 118 on any of the components of system 200 described above. Such a surface may impact and/or be impacted by process parameters such as heat, radiation and/or pressure. Such surfaces may be exposed to and/or interact with chemical species used during substrate processing including, for example, precursor(s), reactant(s), purge/carrier gas, plasma(s) and/or contaminant(s). Interactions between the chemical species and such surfaces may result in condensation, adhesion, lamination, etching, delamination, or the like, or a combination thereof. In an example, a functional feature 116 as described herein may be formed on one or more surfaces of any of the components of system 200.

FIG. 2B is a schematic illustrating an example of a reaction chamber assembly 280 configured to process a substrate 282 (also referred to interchangeably herein as a “wafer” or a “semiconductor wafer”). In an example, various substrate processing procedures may be carried out in reaction chamber assembly 280 comprising, for example, Atomic Layer Deposition (ALD), Chemical Vapor Deposition (CVD), Epitaxial Growth, Plasma Enhanced Chemical Vapor Deposition (PECVD), Atomic Layer Etching (ALE), or Plasma Enhanced Atomic Layer Deposition (PEALD), or the like or combinations thereof.

In an example, reaction chamber assembly 280 may comprise a variety of components within an inner volume 290 comprising one or more surfaces that may impact and/or be impacted by process parameters such as heat, radiation and/or pressure. Such surfaces may be exposed to and/or interact with chemical species used during substrate processing including, for example, precursor(s), reactant(s), purge/carrier gas, plasma(s) and/or contaminant(s). Interactions between the chemical species and such surfaces may result in condensation, adhesion, lamination, etching, delamination, or the like, or a combination thereof. Such components may comprise but are not limited to a vessel (or reaction chamber) 270 having an inner volume 290 defined by upper plane 271, lower plane 272 and one or more walls 273 coupling upper plane 271 and lower plane 272. In an example, one or more heating device 262 components may be disposed outside of vessel 270, integral with vessel 270 and/or within inner volume 290 of vessel 270, as indicated with dashed lines. Heating device 262 may comprise any of a variety of heating devices known to those of skill in the art such as heaters, heating jackets, heating blocks, and/or radial heaters, or the like or a combination thereof.

In an example, showerhead 250, susceptor 252, and pedestal 256 are disposed (at least partially) within inner volume 290. The showerhead 250 assembly is typically located above the substrate 282. Showerhead 250 is configured for vapor distribution to a surface of the substrate 282. During substrate processing, vapor(s) 268 flow from the showerhead 250 in a downward direction toward the substrate 282 and then radially outward over the substrate 282. Susceptor 252 is operable to support substrate 282 and pedestal 256 is configured to support susceptor 252.

In certain examples, one or more liner 258 components, condenser plate 254 components, and/or shield 260 components may be disposed with in inner volume 290 of vessel 270. Liner 258 components may be removeable for maintenance service and cleaning and/or to create a more uniform interior surface for the chamber to improve gas flow patterns, thermal gradients, and deposition uniformity within the reaction chamber assembly 280. In some examples, condenser plate 254 components may be used to control a temperature within the reaction chamber assembly 280 and/or to “getter” or capture precursor and/or byproducts during a wafer processing purge step. In an example, a condenser plate 254 may be configured to operate at a lower temperature than the rest of reaction chamber assembly 280. This temperature difference may cause precursor and/or byproducts to condense on condenser plate 254, helping to remove them from the reaction chamber assembly 280.

In another example, reaction chamber assembly 280 may comprise one or more shield 260 components. In an example, a shield 260 may be operable to protect a valve 264 from reactive species, for example, as they are purged from an interior volume 290 of reaction chamber assembly 280. Shield 260 may be fixedly or removably attached to valve 264 using an appropriate fastener or permanent coupling such as a weld. Shield 260 may be employed in conjunction with a gas curtain 266 to mitigate contact by chemical precursor(s) from the reaction chamber assembly 280 reaching valve 264 during a purge process. In an example, chamber inner surface 278 may be modified to comprise a functional feature 116.

In another example, reaction chamber assembly 280 may comprise an exhaust port 277 and gas mixing manifold 279. In an example, exhaust port 277 may be operable to remove gas from the reaction chamber 270. Gas mixing manifold 279 may be configured to supply reactant and inactive gases to the showerhead device 250. In an example, various surfaces on exhaust port 277 and/or gas mixing manifold 279 may be modified to comprise a functional feature 116.

The design and functionality of reaction chamber assembly 280 components depends on the desired process and corresponding chemical reactions. For simplicity, FIG. 2 illustrates a high-level abstraction and does not show an exhaustive list of components of a reaction chamber assembly 280 contemplated to come within the scope of the current disclosure. In particular examples, a reaction chamber assembly 280 can comprise various combinations of the components shown, one or more of the illustrated components, fewer than all of the components shown, different components and/or different additional components. A reaction chamber assembly 280 or components thereof may be tailored to the specific requirements of the process it is designed to facilitate.

In an example, functional feature 116 may be tailored to respond to process variables within a processing environment of a reaction chamber assembly 280 during a semiconductor manufacturing process. Such a functional feature 116 may comprise any one or more of a variety of patterns, textures, nanoscale structures, colors, oxidation, anodization, emissivities or roughness, or a combination thereof.

In an example, functional feature 116 may yield a selected functionality enabling modified surface 118 to respond to contact with process chemicals, process conditions, heat and/or radiation in a deliberate and/or prescribed manner during a semiconductor manufacturing process. For example, laser processing system 100 may form a functional feature 116 comprising a texture on a surface of a showerhead 250 to provide the surface with a selected emissivity matching the emissivity of a seasoned showerhead (i.e., to pre-season a component). As used herein a “seasoned” component such as a showerhead 250 is one that has been “burned-in” or has been used in processing to such an extent that the emissivity is substantially stabilized. A showerhead 250 when new typically has a lower emissivity compared to the emissivity of a showerhead that has been used in previous processes. Over successive semiconductor manufacturing processes, the emissivity of components such as a showerhead changes as film deposition increases. The benefit of such a pre-seasoned component is that the emissivity is stabilized which may reduce drift in process characteristics. Additionally, modifying a surface 118 of a reaction chamber assembly 280 component may improve quality and throughput by reducing burn-in time and improving surface characteristics to support stable processes and reduce contamination due to customized surface characteristics tailored to specific semiconductor manufacturing processes.

FIG. 3 is a schematic diagram illustrating examples of semiconductor manufacturing system 200 and/or reaction chamber assembly 280 components a workpiece 102 may comprise, in accordance with examples of the present technology. In an example, a laser processing system (e.g., laser processing system 100, see FIG. 1) may be configured to direct pulsed optical beam 106 to a surface of a component of reaction chamber assembly 280 to form a functional surface 116 thereon. Such a modification may be tailored for specific semiconductor manufacturing applications as is described herein.

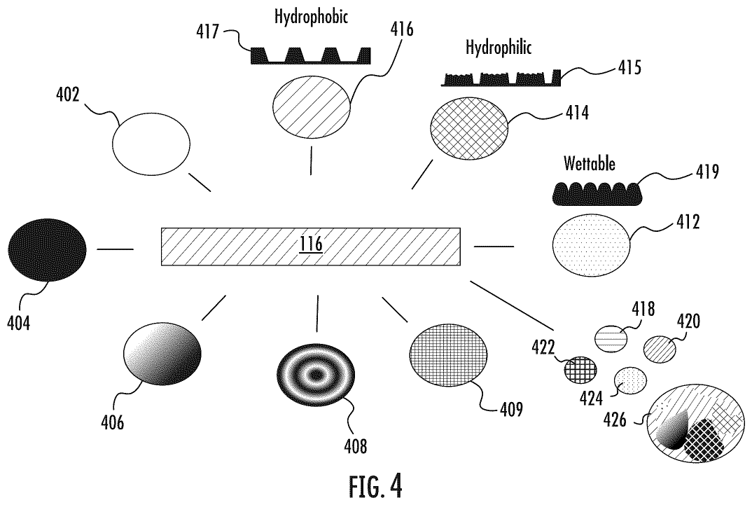

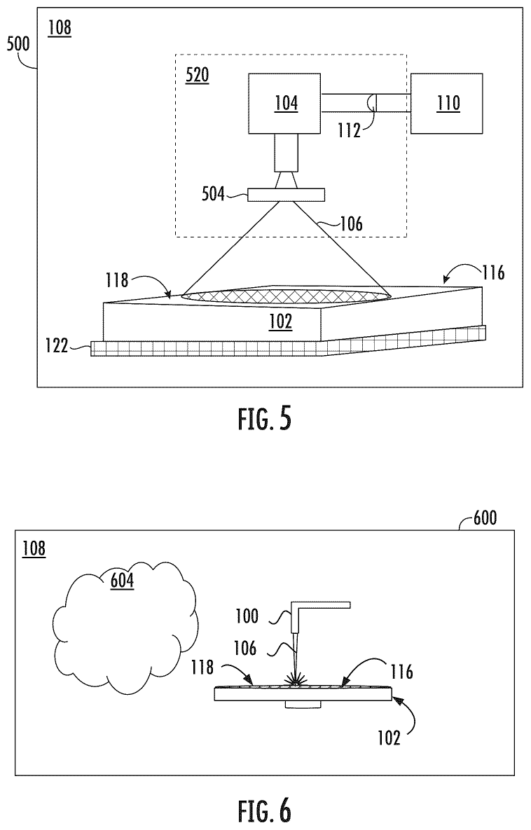

In an example, one or more functional features 116 may be formed in a variety of surfaces of components, including but not limited to: surface 350 of showerhead 250, surface 351 of gas mixing manifold 279, surface 353 of exhaust port 277, surface 355 of gas line 231, surface 352 of susceptor 252, surface 354 of condenser plate 254, inner surface 278 of reaction chamber 270, surface 360 of shield 260, surface 358 of liner 258, surface 362 of heating device 262 and/or surface 356 of pedestal 256. Surfaces 350, 354, 352, 278, 360, 358, 362, or 356, or a combination thereof, may be modified to form a functional feature 116 thereon to change or alter surface characteristics. Such an alteration may be made to tailor respective component surfaces to particular semiconductor processes to which said surfaces will be exposed. Such customization of the surface characteristics to fit a particular process may stabilize processes and/or reduce introduction of contaminants into the reaction chamber assembly 280 leading to improved throughput, higher quality devices and/or process efficiency. These alterations may be made using laser processing system 100 (see FIG. 1), 500 (see FIG. 5) and/or 600 (see FIG. 6). Laser processing systems 100, 500, and/or 600 may be configured to perform a variety of material processing operations on surfaces 350, 354, 352, 278, 360, 358, 362, or 356, or a combination thereof, including but not limited to: thermal ablation (for example, due to heating, melting, vaporization), cold ablation (for example, due to Coulombic explosion), etching, marking, cutting, scoring, scribing, patterning, anodizing, oxidizing, laser surface alloying, micro-machining, roughening, or texturizing, or the like, or a combination thereof.

A functional feature 116 may be formed in surface 352 of susceptor 252. its surface could be roughened to increase surface area, thereby enhancing adhesion properties. In an example, the condenser plate 254 serves a dual purpose: maintaining a cool environment at the reaction chamber's lower section and encouraging the condensation of precursor gases on its upper surface 354, which may benefit from a laser-induced pattern to optimize condensation rates.

In an example, liner 258 may act as a protective barrier, its surface 358 may be textured to minimize unwanted reactions. Shield 260 could have its surface 360 roughened to reduce particulate contamination. Heater 262 radiates heat; a pulsed laser could modify its surface 362 to tailor thermal emissivity. Finally, the chamber inner surface 278 may be patterned to alter its wettability to control for optimal substrate processing.

In particular examples, a functional feature 116 that may be formed on surface 350 of showerhead 250 may be a texture having an emissivity greater than about 0.75 to preseason the showerhead as discussed above.

In an example, a functional feature 116 that may be formed on surface 352 of susceptor 252 may be one or more millimeter to micron scale micro-machined structures having tribological properties such as a coefficient of friction that is greater than a coefficient of friction of surface 352 prior to forming functional feature 116. Such a modified tribological property of surface 352 may be sufficient to aid in providing a stable support to a substrate 282.

In certain examples, a functional feature 116 that may be formed on surface 354 of condenser plate 254 may be patterns having tribological properties such as surface absorption, surface tension, surface free energy, hydrophilicity, wetting, and/or Van der Waals Forces that are sufficient to adhere material that condenses thereon, wherein one or more of the tribological properties are greater, stronger than and/or higher than that of the same tribological properties of surface 354 prior to forming functional feature 116. Such modified tribological properties of surface 354 may be sufficient to improve adhesion and reduce delamination within the reaction chamber.

In various examples, a functional feature 116 that may be formed on inner surface 278 of reaction chamber 270 may comprise a topology having a graded emissivity and/or one or more tribological properties wherein the emissivity and/or one or more tribological properties change over a particular length L, such as a height 292 of inner surface 278 (e.g., from lower plane 272 to upper plane 271) or about a circumference of the inner surface 278 creating an emissivity gradient or tribological property gradient.

In an example, a functional feature 116 that may be formed on surface 360 of shield 260 may comprise a roughness having one or more tribological properties such as hydrophobicity that is greater than a hydrophobicity of surface 360 prior to forming functional feature 116. Such modified tribological properties of surface 360 may be sufficient to aid in shielding a portion of reaction chamber assembly 280 from contact with processing chemicals.

In a particular example, a functional feature 116 that may be formed on surface 358 of liner 258 may have a surface finish having tribological properties such as surface free energy that is less than the surface free energy of surface 358 prior to forming functional feature 116. Such modified tribological properties of surface 358 may be sufficient to aid in providing a low reactivity protective liner that may facilitate cleaning and maintenance.

In an example, a functional feature 116 that may be formed on surface 362 of heating device 262 may be one or more millimeter to micron scale micro-machined structures having emissivity that is different from than an emissivity of surface 362 prior to forming functional feature 116. Such modified emissivity of surface 362 may improve stability of semiconductor manufacturing processes.

In another example, a functional feature 116 that may be formed on surface 356 of pedestal 256 may be a laser surface modification having emissivity and/or one or more tribological properties such as friction, wear, lubrication, chemical reactivity, surface absorption, surface tension, surface free energy, hydrophilicity, hydrophobicity, wetting, and/or Van der Waals Forces that is different from the emissivity or tribological properties of surface 356 prior to forming functional feature 116.

In an example, a functional feature 116 that may be formed on surface 354 of condenser plate 254 may be one or more millimeter to micron scale micro-machined structures having tribological properties such as surface free energy, hydrophilicity, wetting, and/or Van der Waals Forces that is greater than tribological properties of surface 354 prior to forming functional feature 116. Such modified tribological properties of surface 354 may be sufficient to aid in providing increase condensation on condenser plate 254 to remove unused precursor or contaminants from a reaction chamber assembly 280.

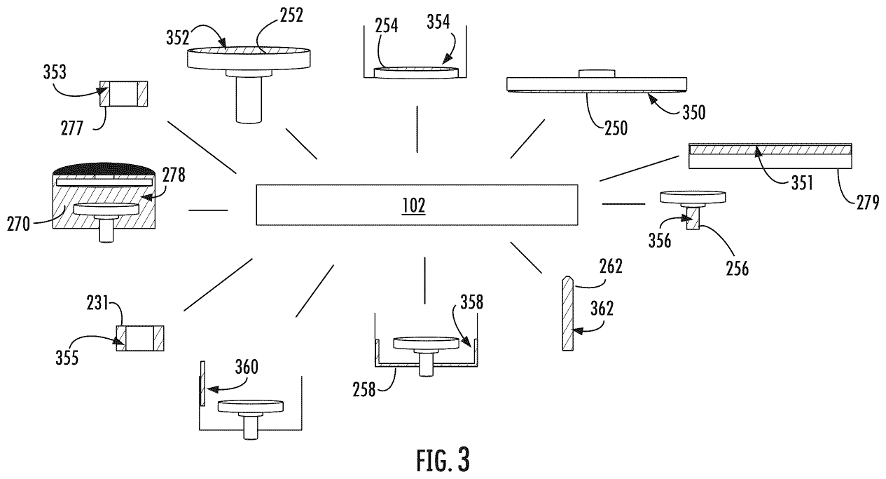

Turning now to FIG. 4 in which is illustrated an array of examples of functional features 116 that may be formed on workpiece 102, in accordance with examples of the present technology. For simplicity, FIG. 4 illustrates a high-level abstraction of functional features 116 and does not show an exhaustive list of functional features contemplated to come within the scope of the current disclosure.

Functional feature examples 402-408 illustrate various emissivities that may be formed on a surface (e.g., surface 118, see FIG. 1) in accordance with examples of the present technology. Emissivity is a measure of a material's ability to emit infrared energy. It may be measured on a scale from 0 (no emission) to 1 (perfect emitter). In some embodiments, emissivity of a surface may be modified using laser processing system 100 (see FIG. 1), 500 (see FIG. 5) and/or 600 (see FIG. 6). In general, light-colored or highly reflective materials tend to have a low emissivity. This is because these materials reflect a significant portion of the incident light rather than absorbing it and re-emitting it as thermal radiation. On the other hand, dull or darker colored materials usually have a high emissivity. They absorb more incident light and re-emit it as thermal radiation. In certain examples, high energy pulsed laser contact on a metal surface (e.g., surface 118) may thermally grow an oxide including but not limited to aluminum oxide (AlOx) and/or titanium oxide (TiOx). Oxide growth may change the color of a surface and/or darken the surface (e.g., surface 118) and change its emissivity, increasing or decreasing the emissivity. Light to dark characteristics may also be due to surface texture, microstructures, patterning, and/or roughness, or the like or combinations thereof. Further, emissivity of a surface also depends on factors like its chemical composition.

Example functional feature 402 is representative of a surface 118 characterized by low, substantially uniform emissivity. Functional feature 402 may have an emissivity that is between about 0.001 and about 0.75, or is between about 0.001 and about 0.5, or is between about 0.001 and about 0.25, or any appropriate range. In an example, functional feature 402 may be useful on one or more component surfaces within semiconductor manufacturing system 200 and/or reaction chamber assembly 280 (see FIGS. 2A-2B) for thermal management, process control and/or efficiency.

Example functional feature 404 is representative of a surface 118 characterized by high, substantially uniform emissivity. Functional feature 404 may have an emissivity that is between about 0.5 to about 0.99, or between about 0.6 and about 0.95, or between about 0.7 and about 0.95, or any appropriate range. In an example, functional feature 404 may be useful on one or more component surfaces within semiconductor manufacturing system 200 and/or reaction chamber assembly 280 (see FIGS. 2A-2B) for process control and/or improved thermal transfer.

Example functional feature 406 is representative of a surface 118 characterized by an emissivity gradient from low to high emissivity. An emissivity gradient of example functional feature 406 may have an emissivity that gradually changes over a surface (e.g., surface 118) between about 0.001 and about 0.99, or between about 0.1 and about 0.95, or between about 0.2 and about 0.8, or between about 0.3 and about 0.7, or any appropriate range. In an example, functional feature 406 may be useful on one or more component surfaces within semiconductor manufacturing system 200 and/or reaction chamber assembly 280 (see FIG. 2A-2B) for controlled heat distribution, tailoring process conditions, process control and/or improved thermal transfer.

Example functional feature 408 is representative of a surface 118 characterized by an emissivity pattern where emissivity varies in a pattern from lower to higher emissivity. The pattern may be regular and repeating or may be irregular or random. An emissivity pattern of example functional feature 408 may have an emissivity that varies over a surface (e.g., surface 118) from between about 0.001 about 0.99, or between about 0.1 and about 0.95, or between about 0.2 and about 0.8, or between about 0.3 and about 0.7, or any appropriate range. In an example, functional feature 408 may be useful on one or more component surfaces within semiconductor manufacturing system 200 and/or reaction chamber assembly 280 (see FIGS. 2A-2B) for controlled heat distribution, tailoring process conditions, and/or process control.

Example functional feature 409 is representative of a surface 118 characterized by a roughness. In an example, roughness may be measured in nanometers (nm) or angstroms (Å) or in Root Mean Square Roughness (Rq). In an example, roughness of example functional feature 409 may have an Ra that varies over a surface (e.g., surface 118) from between about 0.5 μm and about 20 μm, or between about 1 μm and about 15 μm, or between about 1.5 μm and about 7 μm, or any appropriate range. In an example, functional feature 409 may be useful on one or more component surfaces within semiconductor manufacturing system 200 and/or reaction chamber assembly 280 (see FIGS. 2A-2B) for controlled heat distribution, tailoring process conditions, and/or process control. As in example functional features 402-408, roughness may be varied across a surface 118, for example, as a gradient and/or pattern.

Example functional features 418-426 are representative of a surface 118 characterized by one or more patterns. Patterns may be regular and repeating and/or random. A surface pattern may significantly affect interactions within a reaction chamber conditions and chemistries. For example, patterns especially those that are intricate or complex (e.g., examples 420-426), can increase the effective surface area of the material. This can enhance the interaction between the surface and the reactants, potentially improving the efficiency of the reaction, adhesion of deposited materials, creating active sites for catalysis. Thus, example functional features 418-426 may be useful on one or more component surfaces within semiconductor manufacturing system 200 and/or reaction chamber assembly 280 (see FIGS. 2A-2B). As in example functional features 402-408, patterns may be varied across a surface 118, for example, as a gradient and/or multiple different patterns may be applied to a surface 118 as in example 426.

Example functional feature 414 is representative of a surface 118 characterized by hydrophilicity. In an example, hydrophilicity is often measured using the water contact angle (degrees). A lower contact angle indicates higher hydrophilicity. If the contact angle is less than about 90°, the surface is hydrophilic, meaning it has a high affinity for water. In an example, hydrophilicity of example functional feature 414 may be induced by laser surface modification to provide hydrophilic microstructures 415 (in profile) in a surface (e.g., surface 118). The hydrophilic microstructures 415 are an abstracted example and hydrophilic microstructures 415 may comprise any shape microstructure with hydrophilic properties. In an example, functional feature 414 may be useful on one or more component surfaces within semiconductor manufacturing system 200 and/or reaction chamber assembly 280 (see FIGS. 2A-2B). As in example functional features 402-408, hydrophilicity may be varied across a surface 118, for example, as a gradient and/or pattern.

Example functional feature 416 is representative of a surface 118 characterized by hydrophobicity. Like hydrophilicity, hydrophobicity is also measured using the water contact angle. A higher contact angle indicates higher hydrophobicity. If the contact angle is greater than 90°, the surface is considered hydrophobic, or water-repelling.

In an example, hydrophobicity of example functional feature 416 may be induced by laser surface modification to provide hydrophobicity microstructures 417 (in profile) in a surface (e.g., surface 118). The hydrophobicity microstructures 417 are an abstracted example and hydrophobicity microstructures 417 may comprise any shape microstructure with hydrophobicity properties. In an example, functional feature 416 may be useful on one or more component surfaces within semiconductor manufacturing system 200 and/or reaction chamber assembly 280 (see FIG. 2A-2B). As in example functional features 402-408, hydrophobicity may be varied across a surface 118, for example, as a gradient and/or pattern.

Example functional feature 412 is representative of a surface 118 characterized by wettability. Wettability is also measured using the contact angle. A lower contact angle indicates better wettability. Wettability is a measure of the tendency of a liquid (not limited to water) to spread across a surface. It is commonly characterized using the contact angle, which is the angle formed by a liquid at the three-phase boundary point where a liquid, gas, and solid intersect. If the contact angle is less than about 90°, the surface is considered to have good wettability or high wettability. This means the liquid tends to spread out, forming a flatter droplet. If the contact angle is greater than about 90°, the surface is considered to have poor wettability or low wettability. In this case, the liquid tends to “ball up” or bead up.

In an example, wettability of example functional feature 412 may be induced by laser surface modification to provide wettability microstructures 419 (in profile) in a surface (e.g., surface 118). The wettability microstructures 412 are an abstracted example and wettability microstructures 417 may comprise any shape microstructure with desired wettability properties (high or low). In an example, functional feature 412 may be useful on one or more component surfaces within semiconductor manufacturing system 200 and/or reaction chamber assembly 280 (see FIG. 2A-2B). As in example functional features 402-408, wettability may be varied across a surface 118, for example, as a gradient and/or pattern.

Anisotropic wettability refers to direction-dependent wettability. It is also measured using the contact angle, but the measurement must be taken in different directions. May be useful in a gas manifold 279 where the direction of the gas flow may be affected by a direction of wettability. For example, where the direction of wettability may align with an intended or desired gas flow.

Friction can be measured using various units, depending on the specific context. An atomic-scale measure of friction is the coefficient of friction, which typically ranges between about 0.01 for smooth interfaces and about 1 for rough interfaces. Large values of the coefficient of friction reflect the fact that interatomic bonds at the interface are being broken or rearranged during the relative motion of the bodies.

FIG. 5 is a schematic diagram illustrating an example of a laser processing system 500, in accordance with examples of the present technology. In an embodiment, a laser processing system 500 may include a pulsed optical beam source 110 that generates a pulsed optical beam 106. This source 110 can introduce the beam 106 into an optical assembly 520 with various components, such as a beam expander 112 and/or optical lens 114 which are designed to shape and direct optical beam 106 toward workpiece 102. The optical assembly 520 may also feature a scanner 104 to adjust the beam's 106 position and movement across a surface 118. Additionally, the assembly 520 may include stage 122 to hold the workpiece 102.

In an example, optical assembly 520 may also include an optical element 504. Optical element 504 may comprise a diffractive optical element or grating (e.g., a beam splitter).

In an example, Diffractive Optical Elements (DOEs) may be used to split a single collimated laser beam into several beams with the same optical characteristics as the original beam. The beams are usually separated into 1D or 2D arrays and may be arranged regularly or irregularly. DOEs can be designed to manipulate the phase across the aperture to create a desired intensity pattern in the far field. More particularly, a beam splitter such as Edmund Optics HOLO/OR Diffractive Beam Splitter may be used in conjunction with a pulsed fiber laser. The diffracted spot field can be moved across a surface 118 or applied in a repeating pattern to create a diffuse, pseudorandom texture across surface 118.

Using a diffuse or split beam may enable improved uniformity and throughput due to processing of a larger area per pulse. Energy distribution may also be more uniform than simply scanning across the surface. A diffuse or split beam array may operate to process material by distributing the fluence across a wider area.

In an example, beam splitters comprise optical devices that split an incident beam of light into two or more beams. They can be plate or cube configurations. Beam splitters may split incoming light into specified ratios and can separate incident light through their structure.

In an example, optical element 504 may be used to split optical beam 106 into several beams or diffraction orders. Such split and/or diffracted optical beam 106 may be directed to surface 118 to create a functional feature 116 by contacting surface 118 to texture, roughen, pattern, microstructure, ablate (thermal or cold), anodize, oxidize, color or the like, or a combination thereof the surface 118.

In an example, one or more controllers 108 may communicate with components of system 500 to manage its operations. Controller 108 may control the optical components within the assembly 520, including the beam expander 112, optical lens 114, optical element 504, and/or scanner 104, to modify beam 106 characteristics such as diameter, shape, diffusion, direction and speed. It may also control the pulsed optical beam source 110 to adjust the beam's 106 pulse width, fluence, frequency, and/or power level. In an example, controller 108 is also configured to direct stage 122 to maneuver workpiece 102 along the x, y, and z axes.

Laser processing system 500 may be configured to contact surface 118 of workpiece 102 with a pulsed optical beam 106 that is directed through an optical element 504 prior to contacting surface 118. In an example, beam splitting may be employed to create more diffuse patterns on workpiece 102. In an example, pulsed laser 106 can be used to texturize, pattern, microstructure, roughen, smooth and/or otherwise modify surface 118 to tune surface characteristics to improve and/or stabilize various semiconductor manufacturing processes.

FIG. 6 is a schematic diagram illustrating an example of a laser processing system 600, in accordance with examples of the present technology. Laser processing system 100 (see FIG. 1) is disposed in a controlled ambient atmosphere 604 to provide an ambient surface treatment comprising one or more substances that may impact or be incorporated into a surface 118 of workpiece 102 before, during or after laser processing of workpiece 102 by optical beam 106. The use of different gases in the controlled ambient atmosphere 604 can change various factors such as the oxidation rate, and doping the gas or the surface 118 with a dopant can create a different type of growth on the surface. This can potentially reduce the amount of processing required by the laser. In an example, ambient atmosphere 604 can alter a surface 118 material's characteristics. Environmental conditions during laser processing, like the choice of gases in the chamber, can affect the oxidation rate and, by extension, the material's properties. to impact reactivity of surface 118 and/or impact surface energy of surface 118. In an example, ambient atmosphere 604 may comprise (increased) oxygen (O₂) to impact reactivity of surface 118 and/or impact surface energy of surface 118, ozone (O₃) to impact reactivity of surface 118 and/or impact surface energy of surface 118, nitrogen (introduced as NH₃ and/or N₂, for example) to impact reactivity of surface 118 and/or impact surface energy of surface 118, carbon (introduced as CO₂ and/or CO, for example) to impact emissivity of surface 118, hydrogen (H₂), to impact hydrophilicity or hydrophobicity of surface 118.

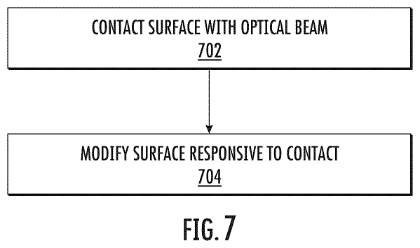

FIG. 7 is a flow chart illustrating an example method for modifying a component surface according to aspects of the disclosed technology. Process 700 begins at block 702 where a surface is contacted with a laser beam, the surface comprising a component. Operations at block 702 may proceed in accordance with examples disclosed and described above with respect to FIGS. 1-6. Process 700 may move to operations at block 704 where a functional feature may be formed in the surface. Operations at block 704 may proceed in accordance with examples disclosed and described above with respect to FIGS. 1-6.

The subject matter of the present disclosure includes all novel and nonobvious combinations and subcombinations of the various systems, components, and configurations, and other features, functions, acts, and/or properties disclosed herein, as well as any and all equivalents thereof.

What is claimed is:

1. A method of modifying a surface, comprising:
contacting, with an laser beam, a surface of a semiconductor tool manufacturing component; and
modifying the surface responsive to the contacting, wherein the modifying the surface comprises:
forming, by micro-machining, etching, ablating, ionizing, anodizing, oxidizing, texturing, or roughening, or a combination thereof, a functional feature in the surface.

2. The method of claim 1, wherein the semiconductor tool manufacturing component is a reaction chamber assembly component.

3. The method of claim 1, wherein the functional feature is selected based on a process to be performed within the reaction chamber.

4. The method of claim 1, further comprising exposing the surface to an ambient surface treatment before, during or after, the contacting.

5. The method of claim 4, wherein the ambient surface treatment comprises oxygen (O₂), ozone (O₃), nitrogen (N₂), ammonia (NH₃), carbon dioxide (CO₂), carbon monoxide (CO), hydrogen (H₂), or a combination thereof.

6. The method of claim 1, wherein the modifying the surface comprises forming a functional feature comprising a pattern, roughening the surface, altering a roughness of the surface, texturing the surface, altering a texture of the surface, altering an emissivity of the surface, or changing a surface energy of the surface, or a combination thereof.

7. The method of claim 1, wherein the functional feature is between about 0.01 mm² and about 1 mm² and comprises an aspect ratio of up to about 10:1 in the surface.

8. The method of claim 1, wherein the surface comprises at least one of: metal, plastic, polymer, stainless steel, stainless steel alloy, aluminum, aluminum alloy, titanium, titanium alloy, quartz, nickel or ceramic.

9. The method of claim 1, wherein the functional feature is characterized by an emissivity of greater than about 0.7.

10. The method of claim 1, wherein the functional feature is characterized by a roughness of greater than Ra of about 0.5 μm and about 20 μm.

11. The method of claim 1, wherein the functional feature is characterized by a roughness of less than about 7 μm.

12. The method of claim 1, wherein the functional feature is characterized by a wettability wherein the contact angle greater than about 90°.

13. The method of claim 1, wherein the functional feature is characterized by a hydrophobicity wherein the contact angle is greater than about 90°.

14. The method of claim 1, wherein the functional feature is characterized by a hydrophilicity of wherein the contact angle less than about 90°.

15. The method of claim 1, wherein the optic laser beam is generated by a nanosecond laser, a picosecond laser or a femtosecond laser.

16. The method of claim 1, wherein the laser beam has a pulse duration that is between about 2 nanoseconds and about 500 nanoseconds or is between about 0.2 picoseconds and about 1 picosecond, or is between about 150 femtoseconds and about 1000 femtoseconds.

17. The method of claim 1, wherein the laser beam has a frequency that is between about 1 kHz and about 10000 kHz or is between about 50 kHz and about 5500 kHz.

18. The method of claim 1, wherein the laser beam has a scan speed that between about 10 mm/s and about 5000 mm/s.

19. The method of claim 1, further comprising adjusting a frequency or a scan speed or a combination thereof to avoid pulse overlap.

20. The method of claim 18, wherein the laser beam has a wavelength that is about 532 nm, about 515 nm, or about 1064 nm.
